(19) United States
(12) Patent Application Publication
(10) Pub. No.: US 2026/0084819 A1
(43) Pub. Date: Mar. 26, 2026

(54) Systems and Methods For Display Stowage Detection

(71) Applicant: Safran Passenger Innovations, LLC, Brea, CA (US)

(72) Inventors: John Gable, Brea, CA (US); Austin Cotler, Brea, CA (US); Randall Bird, Brea, CA (US)

(73) Assignee: Safran Passenger Innovations, LLC, Brea, CA (US)

(21) Appl. No.: 19/122,725

(22) PCT Filed: Nov. 21, 2022
(86) PCT No.: PCT/US2022/050605

§ 371 Date: Apr. 18, 2025

(51) Int. Cl. B64D 11/00; B64D 11/06

(52) U.S. Cl. CPC B64D 11/00153; B64D 11/0646

(57) ABSTRACT

Systems, apparatus, and methods are described herein for display stowage detection. A display device having a display screen can be disposed within a housing, such as an armrest of a vehicle. The housing can have one or more objects disposed within an interior of the housing such that the one or more objects interact with the display screen of the display device when the display device is being inserted into and/or removed from the housing. The specific interaction of the one or more objects with the display screen as the display device is being inserted into the housing causes the display device to automatically power off the display screen.

### FIELD OF THE INVENTION

The field of the invention is display devices, and in particular, detection of stowage of display devices.

### BACKGROUND

The following description includes information that may be useful in understanding the present invention. It is not an admission that any of the information provided herein is prior art or relevant to the presently claimed invention, or that any publication specifically or implicitly referenced is prior art.

Many aircraft and other vehicles have a plurality of display devices disposed through the cabin or vehicle. These display devices can be mounted to the ceiling, walls, overhead compartments, and/or seat backs. Some of the display devices can also be disposed in armrests of the seats of the vehicle.

For display devices stowed within an arm rest, and accessible by a passenger, the display device often rotates ninety degrees about a horizontal axis as the device moves from a viewing position to a stowed position beneath the armrest. For example, the display device may be coupled to a pivoting arm by which the display device may be moved to pivot away from the viewing position to the stowed position, for example, by folding the display device down into the seat arm at a ninety-degree angle. In such circumstances, the display device may include one or more sensors to detect rotation of the display device and when the display device is in the stowed position. Using the sensor data, the device can be configured to automatically power down when in the stowed position.

Unfortunately, some display devices stored within an arm rest are removed in a vertical direction and therefore do not rotate about a horizontal axis as the device moves from a stowed position and is withdrawn from the armrest. In such circumstances, using one or more sensors to detect rotation of the display device will not indicate when the display device is in the stowed position as its relative position does not rotate (i.e., the display screen maintains the same orientation). The requirement to add sensor electronics to existing display devices, seats, or other aircraft cabin structures would be undesirable, costly, and require additional recertification testing, for example.

Thus, there is still a need for systems and methods to detect stowage of a display device.

### SUMMARY OF THE INVENTION

The inventive subject matter provides apparatus, systems, and methods for display stowage detection, and in particular, automatic powering off a display device when the device is determined to be stowed by utilizing simulated touch(es). As used herein, the term “display device” is used herein to mean a unit having a display screen that is used to display media/content to a user. Exemplary display devices include, for example, field replaceable storage units having display screens such as described in U.S. Pat. No. 9,015,776. In some embodiments, the display devices comprise portable computing devices having their own processor and memory, while in other embodiments, the display devices comprise display screens that are communicatively coupled with a computing device that is used to present content on the display screen.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Preferred display screens comprise a touchscreen, meaning that the display screen can act as both an input and output device, and can receive inputs from a user's finger, a stylus, or otherwise. Contemplated touchscreens can be based on various technologies that utilize different methods to sense an input from a user. Such technologies include, for example, resistive touchscreens, capacitive touchscreens (including surface capacitance and projected capacitance), infrared touchscreens, optical imaging touchscreens, and so forth.

Contemplated systems for detecting stowage of a display device comprise a housing configured to receive the display device. In some embodiments, the housing can be part of or disposed beneath an armrest of a seat. Preferably, the housing comprises at least one object disposed within an interior of the housing, such that the at least one object is disposed adjacent to a display screen of the display device when the display device is disposed (i.e., stowed or contained) within the housing.

It is especially preferred that the at least one object is selected and disposed within the housing such that the object(s) is recognized by the display device as an input when the display device is powered on. In other words, as the display device is inserted into (or removed from) the housing, the at least one object interacts with the display screen (touchscreen) of the display device in a specific manner. This could include, for example, a specific path of interaction with the display screen such as from a bottom to a top of the display screen.

Contemplated objects include, for example, stylus tips or other non-abrasive soft touch objects that can contact or otherwise interact with the touchscreen display, as well as metallic objects that can interrupt a capacitive field of the touchscreen display to simulate a fingertip. Of course, any commercially suitable object capable of interacting with the display screen could be used, but preferably those that do not add increased wear to the display screen.

The display device may further comprise a software that automatically powers off the display screen of the display device when the display device detects the at least one object travels/moves from a first position to a second position relative to the display screen. As mentioned above, the movement may be that the at least one object passes by a leading edge of the touchscreen display when stowing the display device and may come to set at the trailing edge of the touchscreen display when fully stowed. Removing the display device from stowage causes the at least one object to travel from the trailing edge to the leading edge of the touchscreen display which can be detected. To avoid accidentally powering off the display screen when in use, it is preferred that the at least one object be mounted in locations/positions that contact the touchscreen display in a combination of locations that a user would least likely touch at the same time, for example, far right and left sides.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a top view of a seat row in a vehicle having three seats.

FIG. 2A is a top view of a housing in a closed position having a display device stowed within.

FIG. 2B is a top view of a housing in an open position having a display device stowed within.

FIG. 2C is a front view of a housing having a display device disposed outside of the housing.

FIG. 2D is a side view of the display device and housing of FIG. 2C.

FIGS. 2E and 2F are front views of the display device and housing of FIG. 2C with the display device partially inserted within the housing.

FIG. 2G is a front view of the display device and housing of FIG. 2C with the display device fully inserted within the housing.

FIG. 2H is a front view of the display device of FIG. 2C indicating the movement of the object from a first position to a second position.

FIG. 3A is a front view of another embodiment of a housing having a display device disposed outside of the housing.

FIG. 3B is a side view of the display device and housing of FIG. 3A.

FIG. 4 is a flow chart of one embodiment of a method for detecting stowage of a display device in a vehicle.

### DETAILED DESCRIPTION

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions. One should appreciate that the inventive subject matter described herein provides a means to detect stowage of a display device using simulated touches on a touchscreen display, preferably through a combination of hardware and software. Using the inventive subject matter, the display screen can be automatically powered off when stowed to reduce power used by the display device and reduce the heat that would otherwise be generated by the display device when stowed in an unventilated structure.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

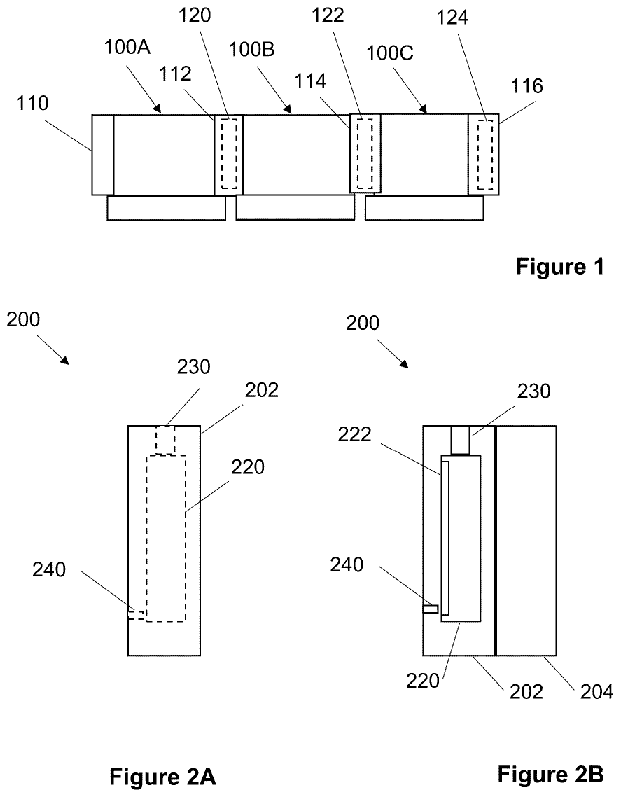

FIG. 1 illustrates a plurality of seats 100A, 100B, 100C disposed in a row with the aircraft or other vehicle. As used herein, the term “vehicle” is defined to include aircraft, boats, busses, cars, trains, and other forms of transportation that can take passengers from one location to another. Each of the seats 100A, 100B, 100C comprises a seatback and one or more armrests. An armrest 110 is disposed at one side of seat 100A with a second armrest 112 disposed between seat 100A and seat 100B. A third armrest 114 is disposed between seat 100B and seat 100C. A fourth armrest 116 is disposed at the other side of seat 100C. While it is shown that adjacent seats share at least one armrest, it is contemplated that each seat could have its own separate armrests.

As shown, armrest 112 comprises a housing configured to store display device 120, armrest 114 comprises a housing configured to store display device 122, and armrest 116 comprises a housing configured to store display device 124. Display devices 120, 122, 124 are shown in dashed lines as they are disposed underneath the armrest with the housing. It is contemplated that one or more of the display devices 120, 122, 124 may be withdrawn vertically from (e.g., up/down) and inserted vertically into the housing of the respective armrest where it is stowed.

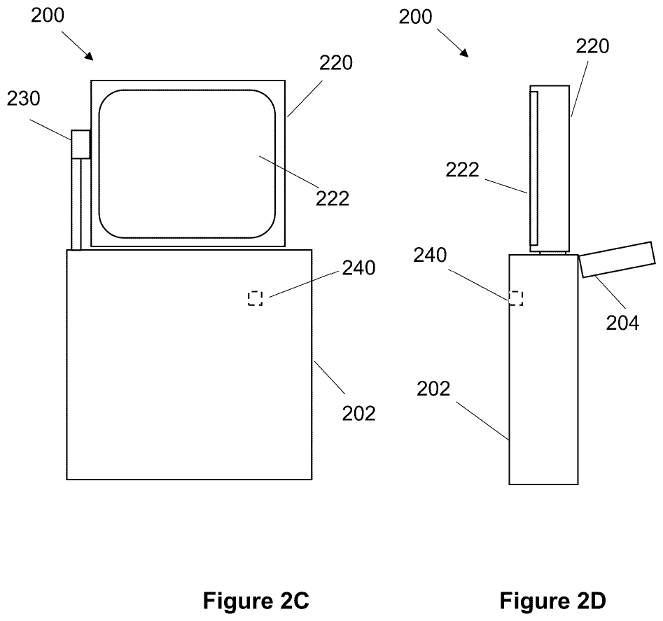

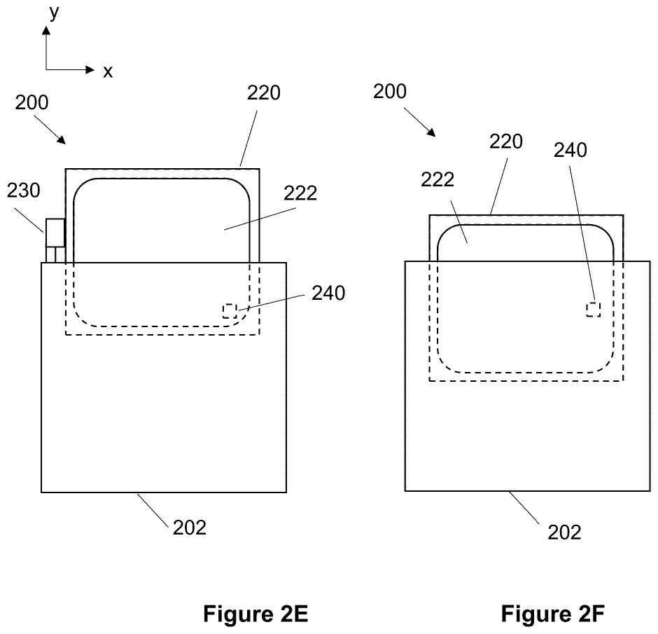

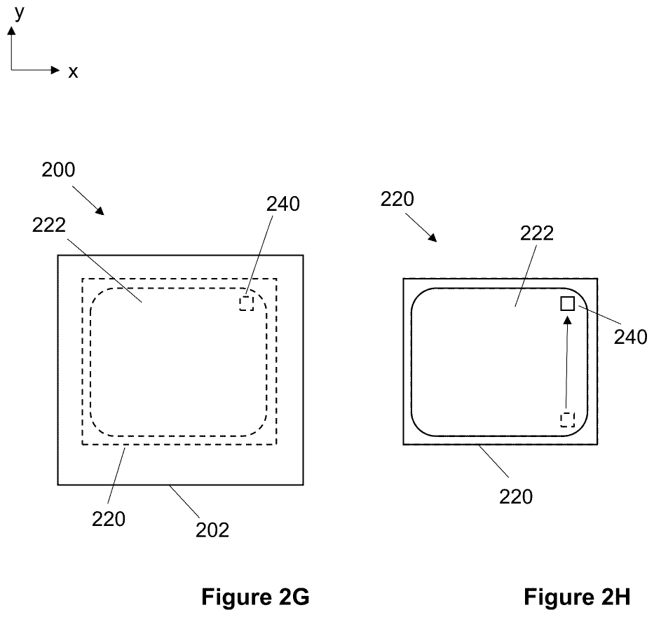

FIGS. 2A-2G illustrate a system 200 for detecting stowage of a display device 220. Display device 220 preferably comprises a display screen 222, and more preferably a touchscreen display, such as those described above.

System 200 comprises a housing 202 configured to vertically receive and store the display device 220, such that the display device 220 is pushed downwardly into the housing 202 for storage. FIG. 2A illustrates the housing 202 in a closed configuration with the armrest on top, while FIG. 2B illustrates the housing 202 in an open configuration (such that the display device 220 can be accessed) with the armrest 204 rotated to create an opening through which to receive or insert the display device 220 into an interior of the housing 202. Thus, the housing 202 can be disposed within or below an armrest 204 of a seat.

As shown, the display device 220 is preferably mounted on and supported within housing 202 by arm 230.

Housing 202 comprises at least one object (here, first object 240) that is disposed within the housing 202 such that the first object 240 is adjacent to the display screen 222 of the display device 220 when the display device 220 is disposed within the housing 202. While FIGS. 2A-2B show the first object 240 as not contacting the display screen 222, in other embodiments, it is contemplated the that first object 240 could be sized and disposed within the housing 202 such that the first object 240 contacts the display screen 222.

Contemplated objects include, for example, stylus tips or other non-abrasive soft touch objects that can contact or otherwise interact with the touchscreen display, as well as metallic objects that can disrupt a capacitive field of the touchscreen display to simulate a fingertip. Alternatively, it is contemplated that one or more wheel(s) made from a soft material held in place by a spring mechanism could be used. Such variation may better be able to work over thick borders of the display screen 222 and reduce the chance of causing abrasions on the display cover lens of the screen 222. Of course, any commercially suitable object capable of interacting with the display screen 222 could be used, but preferably those that do not add increased wear to the display screen 222.

However, it is preferred that the first object 240 does not directly contact the display screen 222 so as to prevent wear and tear of the display screen 222 over time that may be caused by the contact with the first object 240. Specifically, it is preferred that the first object 240 simulates a fingertip touch and be recognized by the display screen 220 as an input when the display screen 222 is powered on and without directly contacting the display screen 222.

The display device 220 preferably comprises a software that automatically powers off the display screen 222 and/or puts the display device 220 into a low power sleep state when the display device 220 detects the first object 240 moving from a first position relative to the display screen 222 to a second position relative to the display screen 222. Alternatively, the software could be programmed to automatically power off the display screen 222 and/or put the display device 220 into a low power sleep state when the first object 240 is detected at the trailing edge for a minimum predetermined period of time in the fully stowed position. To help avoid accidental stowage detection from valid user touches, the full screen swiping gesture that is observed by the display device 220 or its sensor during insertion of the display device 220 into the stowed position can be used to gate the stowage detection function at the trailing edge of the display screen 222. The software may be programmed to continue monitoring specific touch locations and turn on or bring the display screen 222 out of the low power sleep state when the touch coordinates begin to change, indicating that display device 220 is being removed from stowage.

In other words, as the display device 220 is inserted into the housing 202 (or removed from the housing 202), the first object 240 will move along at least a portion of the display screen 222 from the first position to the second position relative to the display screen 222. This is illustrated in FIGS. 2E-2G. The display device 220 can be programmed via software stored in a memory of the display device 220 to automatically power off the display screen 222 when the display device 220 detects the first object 240 moves along the display screen 222 in a specific pattern or line of interaction from the first position to the second position relative to the display screen 222.

It is contemplated that the first object 240 is fixed in place (i.e., stationary) relative to the housing 202 such that the first object 240 does not move where the first object 240 is connected to the housing 202. It is further contemplated that the free end of the first object 240 may move especially where the first object is a soft touch object that directly contacts the display screen 222 and may bend or otherwise flex as the first object 240 comes into contact with the display screen 222.

In some embodiments, the display device 220 can be further configured via software to automatically power on the display screen 222 when the display device 220 detects the first object 240 moves in a specific pattern or line of interaction from the second position to the first position relative to the display screen 222.

FIGS. 2E-2G illustrate how the display device 220 can be vertically inserted (e.g., down along the y axis) into the housing 202. As the display device 220 is inserted into the housing 202, the first object 240 moves from a first position relative to the display screen 222 (shown in FIG. 2E) to a second position relative to the display screen 222 (shown in FIG. 2G). FIG. 2F shows an intermediate position of the first object 240 relative to the display screen 222. FIG. 2G shows the first object 240 in the second position and the display device 220 stowed within the housing 202.

As shown best in FIG. 2H, the first position is vertically below the second position, and the first object 240 interacts with the display screen 222 along a vertical path from the first position to the second position. In some embodiments, the first position comprises a first edge of the display screen 222 and the second position comprises an opposing second edge of the display screen 222.

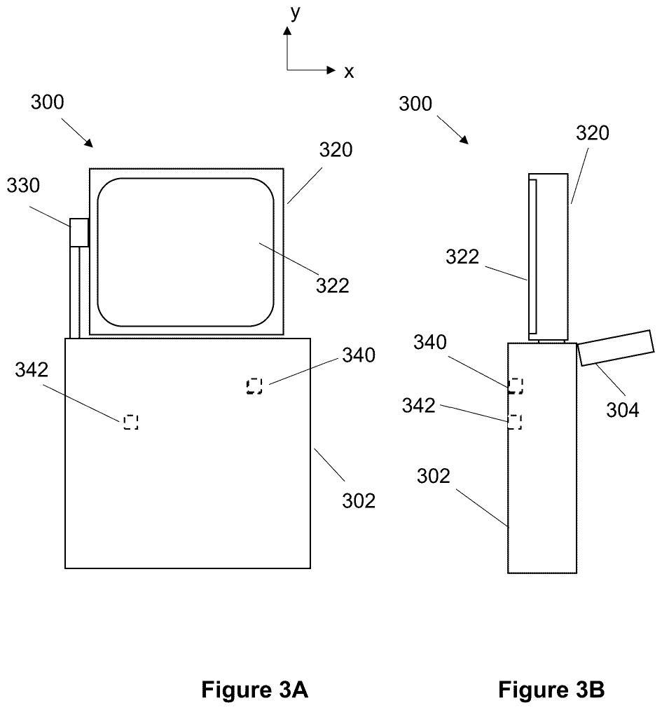

FIGS. 3A-3B illustrate another embodiment of a system 300 for detecting stowage of a display device 320. Display device 320 preferably comprises a display screen 322, and more preferably a touchscreen display, such as those described above.

System 300 comprises a housing 302 configured to receive and store the display device 320. FIG. 3B illustrates the housing 302 in an open configuration (such that the display device 220 can be accessed) with the armrest 304 rotated to create an opening through which to remove or insert the display device 320. It is contemplated that the armrest 304 may be hingedly coupled to the housing 302. As shown, the display device 320 is preferably mounted on and supported within housing 302 by arm 330.

Housing 302 comprises a first object 340 and a second object 342, which are both disposed within the housing 302 such that the first object 340 and the second object 342 are adjacent to the display screen 322 when the display device 320 is disposed within the housing 302. Contemplated objects include, for example, stylus tips or other non-abrasive soft touch objects that can contact or otherwise interact with the touchscreen display, as well as metallic objects that can interrupt a capacitive field of the touchscreen display to simulate a fingertip. Of course, any commercially suitable object capable of interacting with the display screen 322 could be used, but preferably those that do not add increased wear to the display screen 322.

However, it is preferred that the first object 340 and the second object 342 do not directly contact the display screen 322 so as to prevent wear and tear of the display screen 322 over time that may be otherwise caused. Specifically, it is preferred that the first object 340 and the second object 342 each simulates a fingertip touch and be recognized by the display screen 320 as an input when the display screen 322 is powered on.

The first object 340 and the second object 342 may be disposed at different vertical heights (i.e., along the y axis) within the housing. Of course, they may also be disposed at the same vertical height. In addition, it is contemplated that the first object 340 and the second object 342 may be disposed at different horizontal positions (i.e., along the x axis) as shown in FIG. 3A or may be disposed at the same horizontal position but at different heights.

Display device 320 preferably comprises a software that automatically powers off the display screen 322 when the display device 320 detects (i) the first object 340 moving from a first position relative to the display screen 322 to a second position relative to the display screen 322 and (ii) the second object 342 moving from a third position relative to the display screen 322 to a fourth position relative to the display screen 322.

In other words, as the display device 320 is inserted into the housing 302 (or removed from the housing 302), the first object 340 and the second object 342 will each move along at least a portion of the display screen 322. The display device 320 can be programmed via software stored in a memory of the display device 320 to automatically power off the display screen 322 when the display device 320 detects the first object 340 moves along the display screen 322 in a specific pattern or line of interaction from the first position to the second position relative to the display screen 322 and the second object 342 moves along the display screen 322 in a specific pattern or line of interaction from the third position to the fourth position relative to the display screen 322.

It is contemplated that the first object 340 and the second object 342 may be fixed in place relative to the housing 302 such that the first object 340 and the second object 342 do not move where the first object 240 and the second object 342 are each connected to the housing 302. It is further contemplated that the free end of each of the first object 340 and the second object 342 may move.

In some embodiments, the display device 320 can be further configured via software to automatically power on the display screen 322 when the display device 320 detects (i) the first object 340 moves in a specific pattern or line of interaction from the second position to the first position relative to the display screen 322 and (ii) the second object 342 moves from the fourth position to the third position relative to the display screen 322.

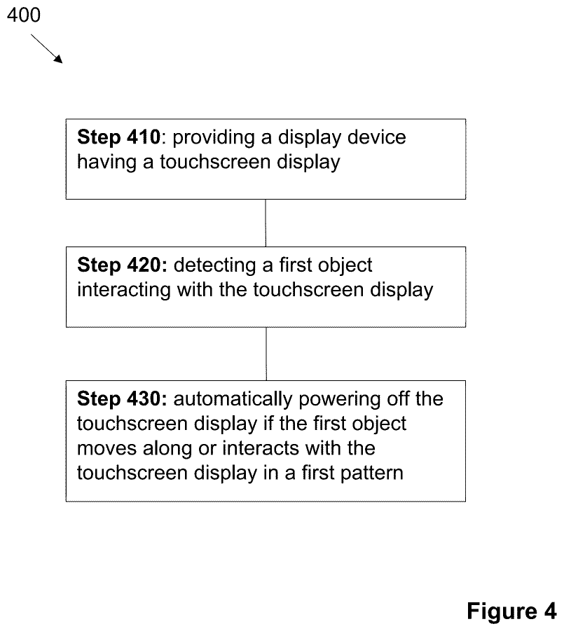

FIG. 4 illustrates one embodiment of a method 400 for detecting stowage of a display device in a vehicle.

In step 410, a display device is provided having a touchscreen display. Preferably, the display device is configured to be vertically stowed within a housing, and an interior of the housing comprises at least one object coupled to or affixed to the housing.

The display device is configured to detect one or more inputs via the touchscreen display using software loaded on the display device. In this manner, the touchscreen display can detect when a finger or other object interacts with or contacts the touchscreen display.

In step 420, the display device detects a first object interacting with the touchscreen display.

In step 430, the touchscreen display can be automatically powered off if the first object moves along or interacts with the touchscreen display in a first pattern. Such interaction could be direct contact of the first object with the touchscreen display or may be interaction or interference with a capacitive field of the touchscreen display. In some embodiment, the first pattern comprises a vertical line from a first position relative to the touchscreen display to a second position relative to the touchscreen display. Preferably, the vertical line is at or near an edge of the screen where users would otherwise not likely make such a gesture.

It is contemplated that the first object is in the second position relative to the touchscreen display when the display device is stowed within the housing. In certain embodiments, the first position is vertically below the second position.

It is further contemplated that the first position comprises a first edge of the touchscreen display and the second position comprises an opposing second edge of the touchscreen display.

In some embodiments, it is contemplated that the touchscreen display can be automatically powered off if the first object moves along or interacts with the touchscreen display in a first pattern and a second object moves along or interacts with the touchscreen display in a second pattern. Similar to the first object, the second object can be detected moving along or otherwise interacting with the touchscreen display.

In such embodiments, it is contemplated that the first pattern comprises the first object moving from a first position to a second position relative to the touchscreen display, and the second pattern comprises the second object moving from a third position to a fourth position relative to the touchscreen display.

It is also contemplated that the first pattern may comprise a vertical line from a first position relative to the touchscreen display to a second position relative to the touchscreen display. The first object may be in the second position relative to the touchscreen display when the display device is stowed.

As discussed above, the first object may comprise a stylus tip or other object capable of acting as an input to the touchscreen display. In other embodiments, it is contemplated that the first object may comprise a metallic object capable of interacting or interfering with a capacitive field of the touchscreen display.

In still further embodiments, it is contemplated that the touchscreen display can be automatically powered on if the first object moves along the touchscreen display in a second pattern, automatically powering on the touchscreen display.

The terms, “component”, “module”, “system”, and the like used herein indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and a computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as the Internet, through data and/or a signal from one component interacting with another component in a local system and a distributed system) having one or more data packets.

Illustrative logical blocks, configurations, modules, circuits, means, logic, and algorithm operations described herein may be implemented by electronic hardware, computer software, or in a combination of electronic hardware and computer software. In order to clearly exemplify interchangeability of hardware and software, the algorithms, steps and/or operations have been generally described in the functional aspects thereof. Whether the functionality is implemented as hardware or software depends on the specific application or design restraints given to the system.

The inventive subject matter discussed herein may be generally implemented by the display device or other computing device, including processor, memory and other computing components installed therein. Those skilled in the art will understand that the inventive subject matter discussed herein may be implemented in association with computer executable software (e.g., computer executable commands and/or other program modules) which may be executed on the display device or one or more computers and/or in combination with other program modules and/or a combination of hardware and software. In general, the software described herein may include one or more routines, programs, components, data structures, and the like that execute a specific task or implement a specific abstract data type.

The display devices generally include one or more computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information but are not limited thereto.

An exemplary environment that implements various aspects of the present disclosure including a computing device (such as display device) comprising a processing device, system memory, and system bus. The system bus connects system components including the system memory (not limited thereto) to the processing device. The processing device may be a predetermined processor among various commercial processors. A dual processor and other multi-processor architectures may also be used as the processing device.

The system bus may be any one of several types of bus structures which may be additionally interconnected to a local bus using any one of a memory bus, a peripheral device bus, and various commercial bus architectures. The system memory includes a read only memory (ROM) and a random-access memory (RAM). A basic input/output system (BIOS) is stored in the non-volatile memories including the ROM, the EPROM, the EEPROM, and the like and the BIOS includes a basic routine that assists in transmitting information among components in the computer at a time such as in-starting. The RAM may also include a high-speed RAM including a static RAM for caching data, and the like.

The display device may also include an interior hard disk drive (HDD) (for example, EIDE and SATA). The hard disk drive may be connected to the system bus by a hard disk drive interface. An interface for implementing an exterior drive includes at least one of a universal serial bus (USB) and an IEEE 1394 interface technology or both of them.

The drives and computer readable media associated therewith provide non-volatile storage of the data, the data structure, the computer executable instruction, and others. In the case of the display device, the drive and the media correspond to storing of predetermined data in an appropriate digital format. In the description of the computer readable media, the mobile optical media such as the HDD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system, one or more application programs, other program module, and program data may be stored in the drive and the RAM. All or some of the operating system, the application, the module, and/or the data may also be cached in the RAM. It will be well appreciated that the present disclosure may be implemented in operating systems which are commercially usable or a combination of the operating systems.

A user may input instructions and information may be inputted in the display devices via the touchscreen display or one or more wired/wireless input devices, for example, pointing devices such as a keyboard and a mouse. Other input devices (not illustrated) may include a microphone, an IR remote controller, a joystick, a game pad, and others. These and other input devices are often connected to the processing device through an input device interface connected to the system bus but may be connected by other interfaces including a parallel port, an IEEE 1394 serial port, a game port, a USB port, an IR interface, and others.

The display screen may be connected to the system bus through interfaces such as a video adapter and the like.

The display device may operate in a networked environment by using a logical connection to one or more remote servers including remote servers through wired and/or wireless communication. The remote servers may be a workstation, a computing device computer, a router, a personal computer, a portable computer, a micro-processor-based entertainment apparatus, a peer device, or other general network nodes and generally includes multiple components or all of the components described with respect to the display device. The logical connection may include a wired/wireless connection to a local area network (LAN) and/or a larger network, for example, a wide area network (WAN).

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A system for detecting stowage of a display device, comprising:
a housing configured to receive a display device, wherein the housing comprises at least one object disposed within the housing and configured to be adjacent a display screen of the display device when the display device is disposed within the housing;
wherein the at least one object is sized and dimensioned to be recognized by the display device as an input when the display device is powered on; and
wherein the display device comprises a software that automatically powers off the display screen when the display device detects the at least one object moving from a first position relative to the display screen to a second position relative to the display screen.

2. (canceled)

3. (canceled)

4. (canceled)

5. The system of claim 1, wherein the first position is vertically below the second position.

6. The system of claim 1, wherein the housing is configured to vertically receive the display device, such that the display device is pushed downwardly into the housing.

7. The system of claim 6, wherein the at least one object interacts with the display screen along a vertical path from the first position to the second position, optionally, wherein the first position comprises a first edge of the display screen and the second position comprises an opposing second edge of the display screen.

8. (canceled)

9. (canceled)

10. (canceled)

11. The system of claim 1, wherein the software is further configured to automatically power on the display screen when the display device detects the at least one object moving from the second position relative to the display screen to the first position relative to the display screen.

12. The system of claim 1, wherein the at least one object comprises a first object and a second object disposed at different heights within the housing.

13. The system of claim 12, wherein the software automatically powers off the display screen when the display device detects (i) the first object moving from the first position relative to the display screen to the second position relative to the display screen and (ii) the second object moving from a third position relative to the display screen to a fourth position relative to the display screen.

14. An apparatus for storing a display device, comprising:
a housing configured to receive and store a display device, wherein the housing comprises a first object disposed within the housing such that the first object is adjacent to a display screen of the display device when the display device disposed within the housing; and
wherein the first object is sized and dimensioned to be recognized by the display device as an input when the display device is powered on.

15. (canceled)

16. (canceled)

17. (canceled)

18. The apparatus of claim 14, wherein the housing comprises an opening configured to receive the display device, such that the display device is pushed downwardly into the housing through the opening, optionally, wherein the first object interacts with the display screen along a vertical path as the display device is received within the housing.

19. (canceled)

20. (canceled)

21. (canceled)

22. The apparatus of claim 14, further comprising:
a second object disposed within the housing; and
wherein the first object and the second object are disposed within the housing at different vertical heights.

23. A method for detecting stowage of a display device in a vehicle, comprising:
providing a display device having a touchscreen display, wherein the display device is configured to be stowed within a housing, and wherein an interior of the housing comprises a first object coupled to the housing;
detecting the first object interacting with the touchscreen display; and
if the first object moves along the touchscreen display in a first pattern, automatically powering off the touchscreen display.

24. The method of claim 23, wherein the first pattern comprises a vertical line from a first position relative to the touchscreen display to a second position relative to the touchscreen display.

25. The method of claim 24, wherein the first object is in the second position relative to the touchscreen display when the display device is stowed within the housing.

26. The method of claim 24, wherein the first position is vertically below the second position.

27. The method of claim 24, wherein the first position comprises a first edge of the touchscreen display and the second position comprises an opposing second edge of the touchscreen display.

28. The method of claim 23, wherein the first object moves along a portion of the touchscreen display.

29. The method of claim 23, wherein the first object contacts the touchscreen display or interacts with a capacitive field of the touchscreen display.

30. (canceled)

31. The method of claim 23, further comprising:
detecting a second object interacting with the touchscreen display, and
wherein the step of automatically powering off the touchscreen display only occurs if the first object interacts with the touchscreen display in the first pattern and the second object interacts with the touchscreen display in a second pattern.

32. The method of claim 31, wherein the first pattern comprises the first object moving from a first position relative to the touchscreen display to a second position relative to the touchscreen display, and wherein the second pattern comprises the second object moving from a third position relative to the touchscreen display to a fourth position relative to the touchscreen display.

33. The method of claim 31, wherein the first pattern comprises a vertical line from a first position relative to the touchscreen display to a second position relative to the touchscreen display, optionally, wherein the first object is in the second position relative to the touchscreen display when the display device is stowed.

34. (canceled)

35. (canceled)

36. (canceled)

37. The method of claim 23, further comprising:
if the first object moves along the touchscreen display in a second pattern, automatically powering on the touchscreen display, wherein the second pattern is opposite of the first pattern.
